(19) United States
(12) Patent Application Publication
(10) Pub. No.: US 2025/0219495 A1
(43) Pub. Date: Jul. 3, 2025

(54) ROTOR OF A ROTATING ELECTRIC MACHINE AND ELECTROMAGNETIC RETARDER AND GENERATOR ASSEMBLY

(71) Applicant: TELMA, Saint-Ouen-L'aumone (FR)

(72) Inventors: Mbarek Akafou, Les Mureaux (FR); Romuald Belance, Deuil La Barre (FR); Nicolas Quennet, Cormeilles En Parisis (FR); Rafik Lounis, CERGY (FR)

(21) Appl. No.: 18/990,430

(22) Filed: Dec. 20, 2024

(30) Foreign Application Priority Data
Dec. 27, 2023 (FR) 2315351

(51) Int. Cl. H02K 5/18

(52) U.S. Cl. CPC H02K 5/18

(57) ABSTRACT

A rotor of to an electromagnetic retarder and generator assembly comprising: a cylindrical body comprising a peripheral face, a lateral connection face; the peripheral face comprising a first edge adjacent to the lateral connection face; an inner ring coaxial with the cylindrical body; fastening arms connected to the inner ring and to the lateral connection face of the cylindrical body; first cooling fins arranged on the peripheral face, the first cooling fins extending along the first edge, the first cooling fins being curved and having a concavity oriented forwards; second cooling fins arranged on the peripheral face, the second cooling fins being curved and having a concavity oriented rearwards.

### TECHNICAL FIELD OF THE INVENTION

The invention relates to a rotor of a rotating machine and in particular to a rotor of an electromagnetic retarder for a vehicle. The invention also relates to an electromagnetic retarder and generator assembly.

### BACKGROUND OF THE INVENTION

A rotor of an electromagnetic retarder and generator assembly comprising an inner ring intended to be mounted on a rotary shaft, a lateral flange and a cylindrical body coaxial with the inner ring is known. The peripheral face of the rotor is smooth or has cooling fins. The flange is constituted by a ring-shaped plate that connects the inner ring to the cylindrical body. The cylindrical body constitutes the armature of the retarder.

Such a rotor is described in patent application FR 18 55 848 filed in the name of the applicant. However, the armature of this rotor is not highly ventilated, and as such the rotor may be deformed by significant use.

It would be desirable to propose a rotor that is not deformed over time under the effect of heat. It would also be desirable to propose a rotor having little aerodynamic loss.

### BRIEF SUMMARY OF THE INVENTION

The present invention relates to a rotor of a rotating electric machine, in particular of an electromagnetic retarder for a vehicle, the rotor being able to rotate about a rotation axis in a direction of rotation, the rotation axis extending in an axial direction, the rotor including:
a cylindrical body comprising a peripheral face, a lateral connection face and a free lateral face opposite the lateral connection face; the peripheral face comprising a first edge adjacent to the lateral connection face and a second edge;
an inner ring intended to be fastened to a rotary shaft, the inner ring and the cylindrical body being coaxial;
fastening arms connected to the inner ring and to the lateral connection face of the cylindrical body,
a plurality of first cooling fins arranged on the peripheral face of the cylindrical body, the first cooling fins being arranged in a first row extending along the first edge, the first cooling fins being curved and having a concavity oriented forwards with respect to the direction of rotation of the rotor,
a plurality of second cooling fins arranged on the peripheral face of the cylindrical body, the second cooling fins being arranged in a second row extending parallel to the first row, the second cooling fins being curved and having a concavity oriented rearwards with respect to the direction of rotation of the rotor.

Advantageously, the shape and the arrangement of the first cooling fins are designed to aspirate a large quantity of air and to improve the cooling of the cylindrical body. Advantageously, the shape and the arrangement of the second cooling fins reduces friction between the air flows and the fins, and reduces aerodynamic losses.

The features described in the following paragraphs may optionally be implemented. They may be implemented independently of one another or in combination with one another:
the first cooling fins have a curvature having a first centre and a first radius of curvature, the first centre being arranged at a first distance from an end of the first edge, the first distance being measured in the axial direction, the ratio between the first radius of curvature and the first distance being between 1 and 2.
the second cooling fins have a curvature having a second centre and a second radius of curvature, the second centre being arranged at a second distance from an end of the second lateral edge, the second distance being measured in the axial direction, the ratio between the second radius of curvature and the second distance being between 1 and 2.
The first centre is arranged at a third distance from the second centre, said distance being measured in a direction perpendicular to the axial direction, the ratio between twice the length of either the first radius of curvature or the second radius of curvature on the one hand, and the third distance on the other hand is between 1.2 and 1.5.
the first cooling fins have a median plane, and the median plane of the first cooling fins forms an angle with the radial plane; the angle being between 40 degrees and 60 degrees, the radial plane being perpendicular to the rotation axis.
The second cooling fins have a median plane, and the median plane of the second cooling fins is parallel to the median plane of the first cooling fins.
The second row extends along the second edge and the rotor includes a crown coaxial with the cylindrical body, and the crown extends only above a central part of the peripheral face, a part of the first cooling fins and a part of the second cooling fins being open to the outside.

Advantageously, the opening above the inlet of the cooling channels facilitates the ingress of air into the cooling channels and the opening above the outlet of the cooling channels facilitates the discharge of air.
The crown has at least one first lateral end, and the first edge is delimited by one end, the first lateral end of the crown being arranged at a fourth distance of between 15 millimetres and 30 millimetres from the end of the first edge, said fourth distance being measured in the axial direction.
The crown includes at least one second lateral end, and the second edge is delimited by one end, the lateral end of the crown being arranged at a fifth distance of between 15 millimetres and 30 millimetres from the end of the second edge, said fifth distance being measured in the axial direction.

The rotor further includes a plurality of third cooling fins fastened to the peripheral face of the cylindrical body, the third cooling fins being arranged in a third row, the third row being adjacent and parallel to the first row, the third cooling fins being curved and having a concavity oriented rearwards with respect to the direction of rotation of the rotor.
The rotor further includes a plurality of fourth cooling fins fastened to the peripheral face of the cylindrical body, the fourth cooling fins being arranged in a fourth row, the fourth row being adjacent and parallel to the third row, the fourth cooling fins being curved and having a concavity oriented rearwards with respect to the direction of rotation of the rotor.

The invention also relates to an electromagnetic retarder and generator assembly, said assembly including a stator and a rotor; the stator comprising an outer face and an inner face; the outer face carrying a retarder inductor arranged to face an inner face of the cylindrical body; the inner face carrying a generator armature; the rotor being formed according to the features set out above, the cylindrical body forming a retarder armature, the inner fastening ring comprising a generator inductor arranged to face the inner face of the stator.

### SHORT DESCRIPTION OF THE FIGURES

FIG. 1 is a perspective view of a part of a rotor according to the invention;

FIG. 2 is a top view of a portion of the rotor of FIG. 1 sectioned along a plane II-II illustrated in FIG. 1;

FIG. 3 is a top view of a part of the rotor shown in FIG. 1;

FIG. 4 is a schematic radial sectional view of a part of an electromagnetic retarder and generator assembly comprising a rotor illustrated in FIG. 1.

### DETAILED DESCRIPTION OF THE INVENTION

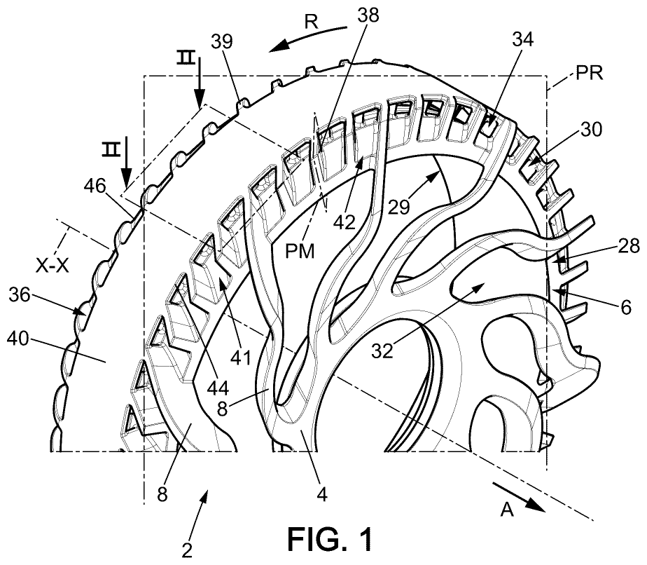

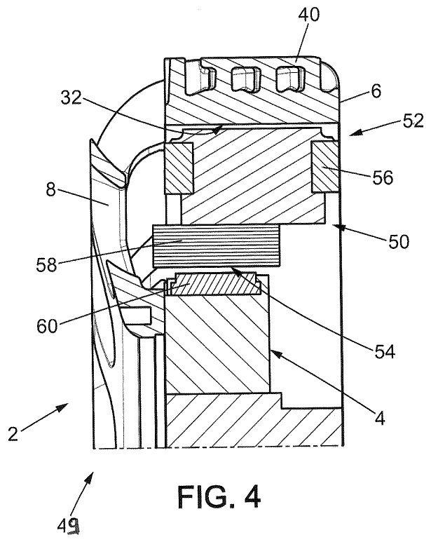

With reference to FIG. 1, the invention relates to a rotor 2 of a rotating electric machine. For example, the rotor 2 is a rotor of an electromagnetic retarder for a vehicle. In particular, this rotor can be mounted in an electromagnetic retarder and generator assembly as illustrated in FIG. 4.

The rotor 2 is able to rotate in a direction of rotation R about a rotation axis X-X extending in an axial direction A. For the purposes of the present description, a radial plane PR perpendicular to the rotation axis X-X is defined.

The rotor 2 includes an inner ring 4 intended to be fastened to a rotary shaft (not shown), a cylindrical body 6 and fastening arms 8 connected to the inner ring and to the cylindrical body.

The inner ring 4 and the cylindrical body 6 are coaxial.

In the non-limiting example illustrated, the rotor includes ten fastening arms. The fastening arms are regularly distributed about the inner ring.

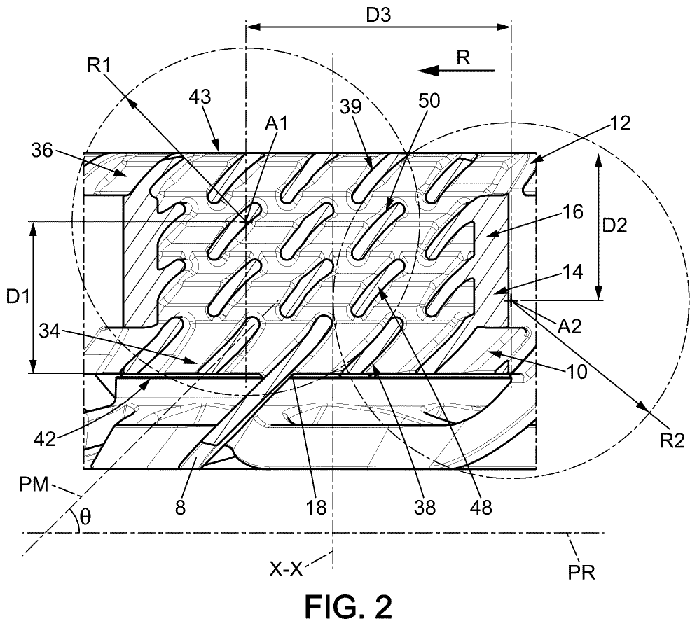

With reference to FIG. 2, the cylindrical body 6 is sleeve-shaped. The cylindrical body 6 comprises a lateral connection face 28, a free lateral face 29 opposite the connection face, a peripheral face 30 or outer face and an inner face 32.

The lateral connection face 28 is the face to which the fastening arms 8 are connected.

The peripheral face 30 comprises a first edge 34 adjacent to the lateral connection face and a second edge 36 opposite the first edge. The first edge 34 of the peripheral face 30 is delimited in the axial direction A by an end 42. The second edge 36 of the peripheral face 30 is delimited in the axial direction A by an end 43.

The cylindrical body 6 comprises first cooling fins 38 and second cooling fins 39. The first cooling fins 38 and the second cooling fins 39 are fastened to the peripheral face 30 of the cylindrical body.

With reference to FIG. 2, the first cooling fins 38 and the second cooling fins 39 are in the form of curved blades. The median plane PM of the first cooling fins 38 is oriented at an angle θ of between 40 degrees and 60 degrees with respect to the radial plane PR. Preferably, the angle θ is substantially equal to 45 degrees. The portion of the first cooling fins closest to the end 43 is directed downstream with respect to the portion of the first cooling fins closest to the end 42, with respect to the direction of rotation of the rotor.

The median plane PM of the second cooling fins 39 is parallel to the median plane of the first cooling fins.

The first cooling fins 38 are arranged in a first row 10. The first cooling fins of the first row are aligned along the first edge 34.

The first cooling fins 38 have a concavity oriented forwards with respect to the direction of rotation R of the rotor. In other words, a vector normal to the concave face of the cooling fins 38 of the first row is directed in the same direction as the direction of rotation R of the rotor with respect to the stator. This enables the first cooling fins 38 to direct a larger quantity of air towards the peripheral face 30 of the cylindrical body.

The first cooling fins 38 have a curvature having a first centre A1 and a first radius of curvature R1. The first centre A1 is arranged at a first distance D1 from the end 42 of the first edge of the cylindrical body. The first distance D1 is measured in the axial direction A. The ratio between the first radius of curvature R1 and the first distance D1 is between 1 and 2.

$$1 < \frac{R 1}{D 1} < 2$$

The second cooling fins 39 are arranged in a second row 12. The second cooling fins 39 are aligned along the second edge 36.

The second cooling fins 39 are also curved and have a concavity oriented rearwards with respect to the direction of rotation R of the rotor. In other words, a vector normal to the concave face of the cooling fins 38 of the second row is directed in a direction opposite to the direction of rotation R of the rotor. This orientation increases the quantity of air discharged out of the rotor, during rotation of the rotor. The second cooling fins 39 have a curvature having a second centre A2 and a second radius of curvature R2. The second centre A2 is arranged at a second distance D2 from the end 43 of the second lateral edge. The second distance D2 is measured in the axial direction A. The ratio between the second radius of curvature R2 and the second distance D2 is between 1 and 2.

$$1 < \frac{R 2}{D 2} < 2$$

The first centre A1 is arranged at a third distance D3 from the second centre A2, said distance being measured in a direction perpendicular to the axial direction A. The ratio between twice the first radius of curvature R1 divided by the third distance D3 is between 1.2 and 1.5.

$$1.2 < \frac{2 R 1}{D 3} < 1.5$$

Similarly, the ratio between twice the second radius of curvature R2 divided by the third distance D3 is between 1.2 and 1.5.

$$1.2 < \frac{2 R 2}{D 3} < 1.5$$

The end 18 of the fastening arms 8 is fastened to the connection face 29. Preferably, the end of the fastening arms project perpendicularly to the peripheral face 30 of the cylindrical body so as to form a cooling fin arranged in the first row 10 and parallel to the first cooling fins.

The cylindrical body 6 further comprises a plurality of third cooling fins 48 fastened to the peripheral face 30 of the cylindrical body. The third cooling fins 48 are arranged in a third row 14 extending parallel to the first row. The third cooling fins 48 are in the form of curved blades. The third cooling fins 48 have a concavity oriented rearwards with respect to the direction of rotation of the rotor. In other words, a vector normal to the concave face of the third cooling fins 48 is directed in a direction opposite to the direction of rotation of the rotor R.

The cylindrical body further comprises a plurality of fourth cooling fins 50 fastened to the peripheral face of the cylindrical body. The fourth cooling fins 50 are arranged in a fourth row 16 extending parallel to the first row. The fourth cooling fins 50 are in the form of a curved blade. The fourth cooling fins 50 have a concavity oriented rearwards with respect to the direction of rotation of the rotor. In other words, a vector normal to the concave face of the fourth cooling fins 50 is directed in a direction opposite to the direction of rotation of the rotor R.

The third cooling fins 48 and the fourth cooling fins 50 extend parallel to the first cooling fins 38.

The median plane PM of the third cooling fins 48 and of the fourth cooling fins 50 is oriented at an angle θ of between 40 degrees and 60 degrees with respect to the radial plane PR. Preferably, the angle θ is substantially equal to 45 degrees.

Preferably, the rotor 2 further includes a crown 40 coaxial with the cylindrical body. The crown 40 forms cooling channels 41 with the cooling fins. These cooling channels promote the cooling of the cylindrical body forming the armature of the rotating machine.

In the preferred embodiment illustrated in the figures, the crown 40 covers the third and fourth cooling fins arranged on a central part of the peripheral face 30 as well as a part of the first and second cooling fins.

A large part of the first cooling fins 38 arranged on the first edge 34 and a large part of the second cooling fins 39 arranged on the second edge 36 of the peripheral face are open to the outside. In other words, a large part of the first cooling fins 38 and a large part of the second cooling fins 39 are not covered by the crown 40. Only a small part of the first cooling fins is covered by the crown. The part of the first cooling fins not covered by the crown has a length of approximately 90% of the total length of the first cooling fins. Similarly, the part of the second cooling fins not covered by the crown has a length of approximately 90% of the length of the second cooling fins.

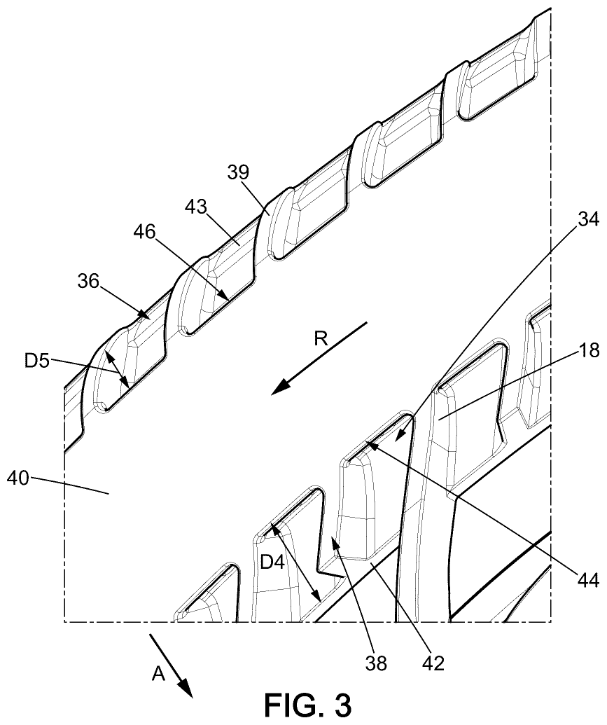

With reference to FIG. 3, the crown 40 is delimited in the axial direction by a first lateral end 44 on one side, and by a second lateral end 46 on the other side. The first lateral end 44 is adjacent to the end 42 of the first edge of the peripheral face. The second lateral end 46 is adjacent to the end 43 of the second edge of the peripheral face.

Preferably, the lateral edge 44 of the crown is arranged at a fourth distance D4 of between 15 millimetres and 30 millimetres from the end 42 of the first edge of the peripheral face. The fourth distance D4 is measured in the axial direction A.

Preferably, the lateral end 46 of the crown is arranged at a fifth distance D5 of between 15 millimetres and 30 millimetres from the end 43 of the second edge. The fifth distance D5 is measured in the axial direction A.

In the non-limiting embodiment shown in the figures, the fourth distance D4 is equal to the fifth distance D5.

Preferably, the end 18 of the fastening arms is also connected to a lateral face of the crown.

With reference to FIG. 4, the invention also relates to an electromagnetic retarder and generator assembly 49. This assembly includes a rotor 2 and a stator 50. The rotor 2 is formed according to the features mentioned above.

The stator 50 comprises an outer face 52 and an inner face 54. The outer face 52 carries a retarder inductor 56 arranged to face an inner face 32 of the cylindrical body. The inner face 54 carries a generator armature 58. The cylindrical body 6 of the rotor 2 forms a retarder armature. The inner fastening ring 4 comprises a generator inductor 60 arranged to face the inner face 54 of the stator.

1. A rotor of a rotating electric machine, in particular of an electromagnetic retarder for a vehicle, the rotor being able to rotate about a rotation axis in a direction of rotation, the rotation axis extending in an axial direction, the rotor comprising:
a cylindrical body comprising a peripheral face, a lateral connection face and a free lateral face opposite the lateral connection face; the peripheral face comprising a first edge adjacent to the lateral connection face and a second edge;
an inner ring intended to be fastened to a rotary shaft, the inner ring and the cylindrical body being coaxial;
fastening arms connected to the inner ring and to the lateral connection face of the cylindrical body;
a plurality of first cooling fins arranged on the peripheral face of the cylindrical body, the first cooling fins being arranged in a first row extending along the first edge, the first cooling fins being curved and having a concavity oriented forwards with respect to the direction of rotation of the rotor; and
a plurality of second cooling fins arranged on the peripheral face of the cylindrical body, the second cooling fins being arranged in a second row extending parallel to the first row, the second cooling fins being curved and having a concavity oriented rearwards with respect to the direction of rotation of the rotor.

2. The rotor according to claim 1, wherein the first cooling fins have a curvature having a first centre and a first radius of curvature, the first centre being arranged at a first distance from an end of the first edge, the first distance being measured in the axial direction, the ratio between the first radius of curvature and the first distance being between 1 and 2.

3. The rotor according to claim 1, wherein the second cooling fins have a curvature having a second centre and a second radius of curvature, the second centre being arranged at a second distance from an end of the second lateral edge, the second distance being measured in the axial direction, the ratio between the second radius of curvature and the second distance being between 1 and 2.

4. The rotor according to claim 3, wherein the first cooling fins have a curvature having a first centre and a first radius of curvature, the first centre being arranged at a first distance from an end of the first edge, the first distance being measured in the axial direction, the ratio between the first radius of curvature and the first distance being between 1 and 2, and wherein the first centre is arranged at a third distance from the second centre, the distance being measured in a direction perpendicular to the axial direction, the ratio between twice the length of either the first radius of curvature or the second radius of curvature on the one hand, and the third distance on the other hand is between 1.2 and 1.5.

5. The rotor according to claim 1, wherein the first cooling fins have a median plane, and wherein the median plane of the first cooling fins forms an angle with the radial plane; the angle being between 40 degrees and 60 degrees, the radial plane being perpendicular to the rotation axis.

6. The rotor according to claim 5, wherein the second cooling fins have a median plane, and wherein the median plane of the second cooling fins is parallel to the median plane of the first cooling fins.

7. The rotor according to claim 1, wherein the second row extends along the second edge and wherein the rotor includes a crown coaxial with the cylindrical body, and wherein the crown extends only above a central part of the peripheral face, a part of the first cooling fins and a part of the second cooling fins being open to the outside.

8. The rotor according to claim 7, wherein the crown has at least one first lateral end, and wherein the first edge is delimited by one end, the first lateral end of the crown being arranged at a fourth distance of between 15 millimetres and 30 millimetres from the end of the first edge, the fourth distance being measured in the axial direction.

9. The rotor according to claim 8, wherein the crown includes at least one second lateral end, and wherein the second edge is delimited by one end, the lateral end of the crown being arranged at a fifth distance of between 15 millimetres and 30 millimetres from the end of the second edge, the fifth distance being measured in the axial direction.

10. The rotor according to claim 1, further including a plurality of third cooling fins fastened to the peripheral face of the cylindrical body, the third cooling fins being arranged in a third row, the third row being adjacent and parallel to the first row, the third cooling fins being curved and having a concavity oriented rearwards with respect to the direction of rotation of the rotor.

11. The rotor according to claim 10, further comprising a plurality of fourth cooling fins fastened to the peripheral face of the cylindrical body, the fourth cooling fins being arranged in a fourth row, the fourth row being adjacent and parallel to the third row, the fourth cooling fins being curved and having a concavity oriented rearwards with respect to the direction of rotation of the rotor.

12. An electromagnetic retarder and generator assembly comprising a stator and a rotor; the stator comprising an outer face and an inner face; the outer face carrying a retarder inductor arranged to face an inner face of the cylindrical body; the inner face carrying a generator armature; the rotor being formed according to claim 1, the cylindrical body forming a retarder armature, the inner fastening ring comprising a generator inductor arranged to face the inner face of the stator.
